(19) United States
(12) Patent Application Publication
(10) Pub. No.: US 2016/0038892 A1
(43) Pub. Date: Feb. 11, 2016

(54) Enhancement of agitation by an innovative blender

(71) Applicants: Gashtaseb Mardani Korai, Sharekord (IR); Maryam Ahankoub, Sharekord (IR); Ida Mardani Korani, Sharekord (IR)

(72) Inventors: Gashtaseb Mardani Korai, Sharekord (IR); Maryam Ahankoub, Sharekord (IR); Ida Mardani Korani, Sharekord (IR)

(21) Appl. No.: 14/455,930

(22) Filed: Aug. 10, 2014

(51) Int. Cl. B01F 7/16; B01F 15/00

(52) U.S. Cl. CPC B01F 7/166; B01F 15/00331; B01F 2215/0052

(57) ABSTRACT

Innovative blender works with two rotors that each one is connected to an impeller. The rotors rotate contrary and transfer energy with two concentric axes configured of a shaft and a casing. The dual rotor causes fluid to be mixed completely without any swirling, drag or vortex, and this caused high agitation of fluid with high efficiency. The main reason for use of such blenders could include: household uses, laboratories, research centers, educational facilities, industries, water and wastewater treatment plants and anywhere that chemical compounds are mixed with fluids such as water or gases rapidly having short agitation time, in either low or high volumes.

### BACKGROUND OF THE INVENTION

Blenders are used to mix or blend a wide range of materials used in different industries, including food, chemical, pharmaceutical, plastic and mineral industries. They are mainly used to mix different materials using different types of blades to make a good quality homogeneous mixture. Included are dry blending devices, paste mixing designs for high viscosity products and high shear models for emulsification, particle size reduction and homogenization. Industrial mixers range from laboratory to production line scale.

They can operate at different temperatures and pressures for mixing different solutions and can also have internal or external heating systems added to them. Options also exist where spray nozzles, and pneumatic or electric systems can be used. Systems can come equipped with hydraulic or electronic soft start mechanisms so that they start and stop smoothly.

In addition to performing typical batch mixing operations, some mixing can be done continuously. Using a machine like the Continuous Processor, one or more dry ingredients and one or more liquid ingredients can be accurately and consistently metered into the machine and see a continuous, homogeneous mixture come out the discharge of the machine. Many industries have converted to continuous mixing for many reasons. Some of those are ease of cleaning, lower energy consumption, smaller footprint, versatility, control, and many others.

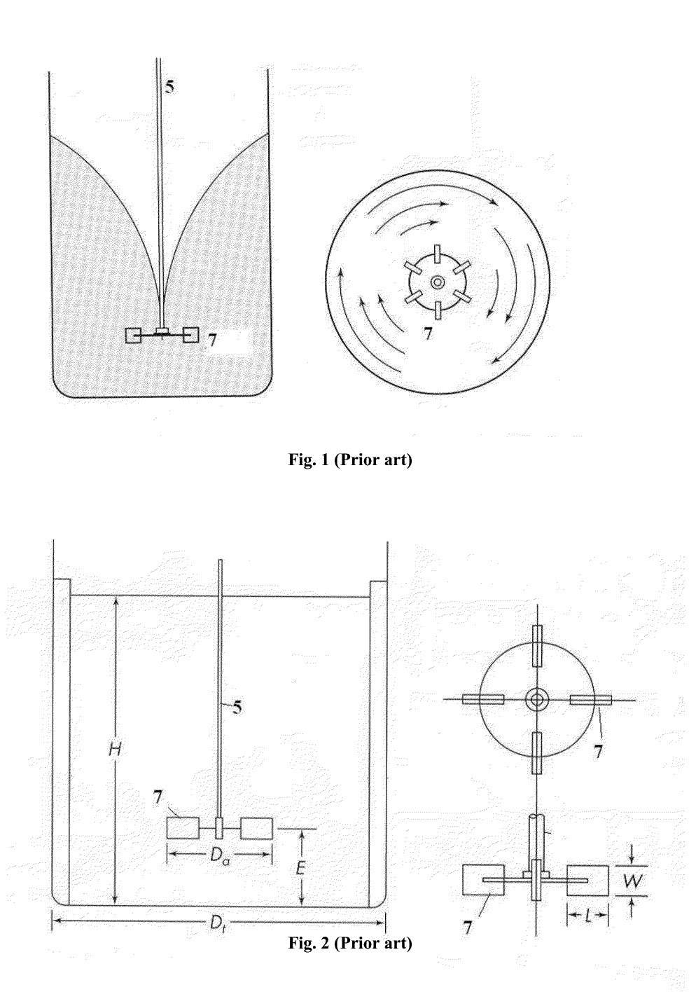

Continuous mixers, such as the twin-screw Continuous Processor, also have the ability to handle very high viscosities. However in all the conventional blenders (See FIGS. 1,2) as the impeller rotates it creates swirling of the fluid therefore the fluid body rotates with the impeller and therefore efficiency is low.

### SUMMARY OF THE INVENTION

The current invention is drawn to a double blade coaxial blender having each blade rotating in opposite directions simultaneously (clockwise and counter clockwise), therefore no fluid swirl is generated and the solid materials combine extremely fast with the fluid, and less energy is used in achieving the final mixture.

This innovative blender maybe used in different scales (small and large) including: household needs, laboratories, research centers, educational facilities, industries, water and wastewater treatment plants and anywhere that a chemical compound is mixed with fluids such as water or gases rapidly and with short agitation time, either in low or high volumes.

### DETAILED DESCRIPTION OF DRAWINGS

FIG. 1 displays a conventional blender with one blade that causes swirling of fluid body

FIG. 2 displays a Conventional Blender with one blade; W=wide L=Long H=High of Fluid D=Diameter E=Elevation from bottom

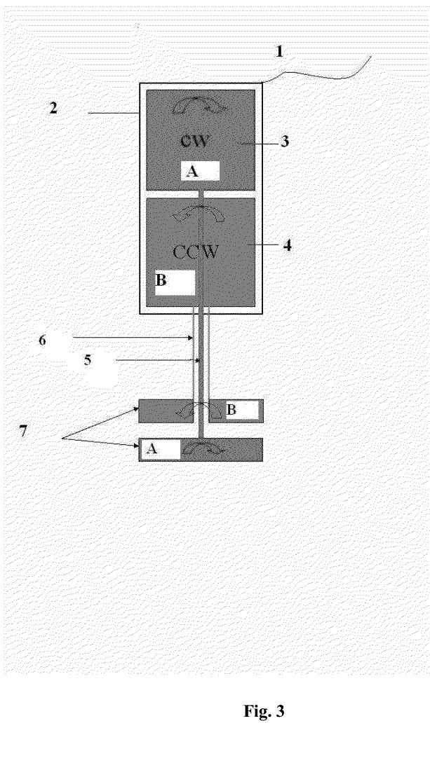

FIG. 3 displays and embodiment of current Innovative Blender with two blades

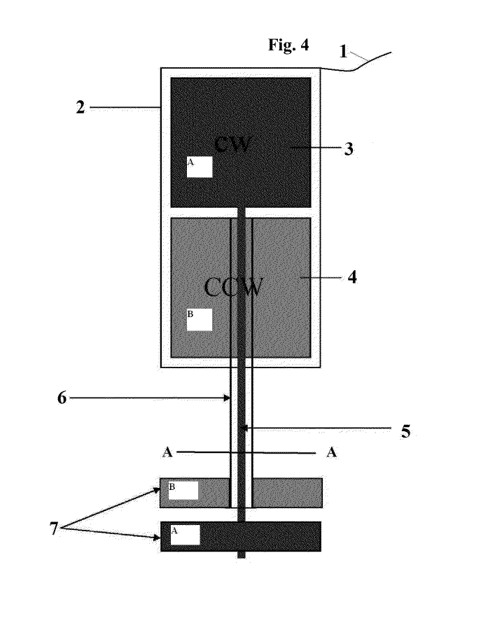

FIG. 4, displays another view of current Innovative Blender with two blades

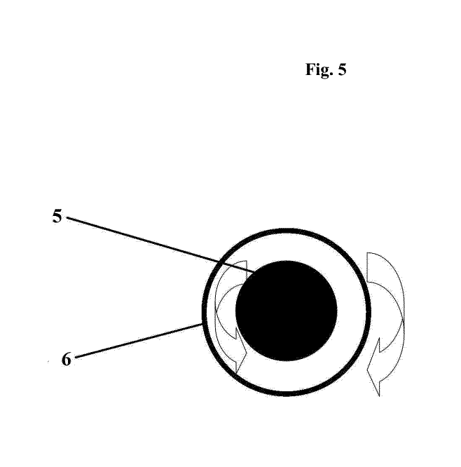

FIG. 5 displays another view of an embodiment of the invention; Shaft and casing Section A-A derivation from FIG. 4

### LIST OF PARTS

1 Electricity cable

2 Case

3 Rotor A rotating clockwise

4 Rotor B rotating counter clockwise

5 Shaft; which transfers mechanical energy to impeller of rotor A

6 Casing; which transfers mechanical energy to impeller of rotor B

7 Blades/Impellers A and B that are connected to rotor A and B

### DETAILED DESCRIPTION OF DIFFERENT EMBODIMENTS

Blenders are implemented for various uses, such as in home for mixing of different types of food such as eggs, juices, and so on; and in chemical industries for mixing of chemical matters, or in water and wastewater treatment plants for mixing of chemical matter such as alum and chlorine and for good sedimentation of colloidal matter.

This innovative blender solves the swirling issue and low efficiency by increasing turbulence and velocity and therefore working more rapidly than its counterpart one blade blenders. Therefore energy consumption is reduced to a great extent and efficiency is high than conventional blender.

As displayed in FIG. 3, the current innovative blender has two coaxial and concentric rotors (A and B) that are connected to two blades 7 by a shaft 5 and a casing 6. Rotors A and B rotate in opposite direction with regards to each other, so if rotor A rotates in Clockwise (CW) direction rotor B rotates in counter clockwise (CCW). Each rotor is attached to a single set of blades 7 and moves that particular blade (FIG. 3).

Rotors A and B are designed to work in different speed and configuration and can switch between different positions and rotation configuration via signals received through electricity cable 1 connected to a control machine (Not shown). For example one option can be a low rotation speed with high combination result or high rotation speed with a lower combination of material result.

In another embodiment the direction and speed of impellers A and B (attached to rotors A and B respectively) can be switched automatically from CW to CCW and then from CCW to CW respectively and periodically at specific times, that aid to high agitation and increase of quality of mixing and higher efficiency.

Another alternative is to use Blades 7 with aerodynamic shape or slops (not shown) and providing suction and discharge of fluid means in each blade 7, wherein when one blade performs suction the other blade discharges fluid.

Blades 7 can be in different sizes and dimensions, such as from 2×5 cm for small scale blenders, best for household usage and up to 20×100 cm for large scale blenders best for industrial and water and waste water treatment plants usages.

In a preferred embodiment rotor A rotates clockwise, rotating the shaft in CW and therefore transferring mechanical energy to impeller A that includes one or more blades 7. On the other hand rotor B rotates counters clockwise and causes casing 6 to rotate in that direction (CCW) therefore transfers mechanical energy to impeller B that includes one or more blades 7.

Shaft 5 transfers mechanical energy via connections with inside of casing 6 that is embedded in the casing 6. In FIGS. 4 and 5 when shaft 5 and casing 6 rotate in opposite directions, impellers A and B also rotate in respective directions similar to shaft 5 and casing 6 respectively, and therefore create high turbulence in the fluid inside a container. This turbulence causes the fluid and solid or liquid material inside the container to mix very fast and with good agitation. Therefore we don't have any swirling or vortex that causes rotation of body of fluid and causes waste of energy and time.

1. A Blender machine comprising a controlling means connected to a first and second rotor; wherein said controlling means sends various predefined signals in order to control rotation, speed and intervals of said first and second rotors; wherein said blender comprises a shaft and a casing; a first impeller and a second impeller connected to said first and second impellers respectively; a first set of blades and a second set of blades each connected to said first rotor and second rotor; wherein said shaft transfers mechanical energy to said first impeller and wherein said casing transfers mechanical energy to said second impeller; wherein said first and second rotors rotate in opposite direction of each other.

2. The blender of claim 1, wherein said first and second blenders are coaxial and concentric with each other, wherein said first rotor rotates said shaft and therefore rotates said first impeller causing said first set of blades to rotate in a same direction as said first rotor and wherein said second rotor rotates said casing in an opposite direction than said first rotor, and therefore said second impeller will rotate in a direction similar to that of said first rotor and therefore causes said second set of blades to rotate as well.

3. The blender of claim 2, wherein said first and second rotors rotate simultaneously and their respective speed and rotation direction changes via said controlling machine; wherein a duration and periodic intervals of said changes is controlled via said controlling machine; wherein each of said first and second rotors rotate in various speed or time intervals in comparison with each other, however they can function with similar configurations as needed.

4. The blender of claim 3, wherein said blender comprises a higher efficiency and have a faster combination and mix of materials in comparison to conventional blenders.

5. The blender of claim 4, wherein said first and second set of blades comprise aerodynamic shapes or slops.

6. The blender of claim 5, wherein said first and second set of blades comprise a suction and discharge means located on their respective surface and body; wherein when said first set of blades performs a suction of fluids inside a container via its respective suction means, said second set of blades performs a discharge of liquids previously sucked inside its respective body via said suction means.

7. The blender of claim 6, wherein said suction and discharge means are controlled and programmed via said controlling means, where speed, flow rate and direction of discharge is programmed for each of said first and second set of blades.

8. The blender of claim 7, wherein said first and second blades comprise different sizes, ranging from 2*5 cm for smaller appliances and up to 0*100 cm for large scale use, such as industrial and water and waste water treatment plants usages.

9. The blender of claim 8, wherein said blender comprises rapid mixing rate while no vortex or swirl is created during rotation of said first and second rotors, and further comprises an increase in settling capacity and reduction of mixing time, reduction of dimension, reduction of costs, reduction of energy.
